(19) United States
(12) Patent Application Publication
(10) Pub. No.: US 2014/0352731 A1
(43) Pub. Date: Dec. 4, 2014

(54) SURFACE CLEANERS AND METHODS FOR USING THE SAME

(71) Applicant: Arrow-Magnolia International Inc., Dallas, TX (US)

(72) Inventors: Tony Atabong, Murphy, TX (US); Curtis Shaw, Irving, TX (US)

(21) Appl. No.: 13/907,549

(22) Filed: May 31, 2013

(51) Int. Cl. C11D 7/26; B08B 9/02; B08B 9/08; B08B 3/08

(52) U.S. Cl. CPC C11D 7/267; B08B 3/08; B08B 9/02; B08B 9/08
USPC 134/22.14; 510/188; 134/26; 134/22.19

(57) ABSTRACT

A cleaning composition suitable for removing soil from a variety of surfaces and a method of using the same are provided. Cleaning compositions according to embodiments of the present invention include at least one carbonate ester, including, for example, ethylene carbonate, propylene carbonate, trimethylene carbonate, and combinations thereof. Depending on the specific application, the compositions may also include at least one surfactant and/or at least one thickener. Cleaning compositions as described herein may be particularly useful for removing soil from surfaces of pipes, vessels, and other equipment associated with the production and/or processing of oil and/or natural gas, such as, for example, equipment associated with a hydraulic fracturing process.

### BACKGROUND

1. Field

One or more embodiments of the present invention relate to cleaning compositions suitable for use on surfaces. More particularly, embodiments described herein may relate to cleaning compositions comprising at least one carbonate ester that are used to remove soil from a surface. In some aspects, the cleaning compositions of the present invention may be used to clean piping or equipment used for the production and/or processing of oil and natural gas.

2. Description of Related Art

In many industrial systems, unwanted materials, such as dirt, grease, oil, mineral deposits, and polymeric materials, may build up within the equipment and/or piping of a processing facility. These unwanted materials may be contaminants that originate from an external source and/or may result from a reaction or interaction of the materials within the system itself. Often, these undesired materials build up on surfaces within the system and often become very difficult to remove with conventional methods or cleaners. At times, removal of such deposits must be done manually, such as, by grinding, cutting, or chipping the deposit from the surface. Not only is this time consuming and expensive, but it also poses a substantial risk of damaging the process equipment.

One application in which such build-ups occur is in systems used for the hydraulic fracturing (“fracing”) of subterranean oil and gas formations. Use of an array of chemicals, including acids, corrosion inhibitors, scaling inhibitors, friction reducers, biocides, gums, thickeners, and salts, in combination with the native fluids results in the formation of a chemically complex, fracing “sludge” that forms deposits within the vessels, equipment, and piping of the system. Not only do these deposits take up valuable processing capacity, but they also interact with the fluid passing through the system, thereby altering the properties of the process fluids and adversely impacting production. The solidified sludge cannot be cleaned with conventional liquids, but, instead, must be mechanically removed from the system internals. This process requires the equipment to be shut down and manually cleaned, which can be very expensive, both in terms of increased maintenance costs and lost production.

Thus, a need exists for a method of removing soil from a surface, including such as piping and other equipment, that is both effective and minimizes downtime. Advantageously, the method and composition could be widely used on a variety of surfaces to remove a range of different soils with the same effectiveness and without adverse effects on the system.

### SUMMARY

In one embodiment, the present invention concerns a method for removing soil from at least one surface of a pipe, vessel, or other piece of equipment associated with an oil and gas production and/or processing system. The method comprises contacting at least a portion of the surface with a cleaning composition that comprises at least one carbonate ester. The contacting is sufficient to remove at least a portion of the soil from the surface to thereby provide an at least partially cleaned surface.

In another embodiment, the present invention concerns a method for removing soil from a surface. The method comprises contacting at least a portion of a surface with a cleaning composition that comprises at least 50 percent by weight of at least one carbonate ester and at least one surfactant and/or a thickener, wherein the contacting is sufficient to remove at least a portion of the soil from the surface.

In yet another embodiment, the present invention concerns a composition for cleaning surfaces comprising at least 50 percent by weight of at least one carbonate ester; up to 20 percent by weight of at least one thickener; and up to 30 percent by weight of at least one surfactant, wherein each of the percentages are based on the total weight of the composition

### DETAILED DESCRIPTION

In accordance with one embodiment of the present invention, a cleaning composition suitable for use on a surface is provided. The composition may include at least one carbonate ester, as well as at least one surfactant and/or thickener. In one embodiment, the compositions described herein may be used to remove soil from the surface effectively and without damaging the surface. As used herein, the term “soil” refers to any undesirable or unwanted component. Examples of soils include, but are not limited to, grease, fats, acidic materials or deposits, basic materials or deposits, petroleum-related deposits, oils, mineral deposits, protein or other food related deposits, mud, loose dirt or earth, organic compounds such as paints or glues, polymeric materials or deposits, and combinations thereof. Cleaning compositions according to embodiments of the present invention may have a wide range of applications, specific embodiments of which will be discussed in detail shortly.

As mentioned previously, the cleaning compositions of the present invention include at least one carbonate ester. The carbonate ester can be a straight chain, branched, or aromatic carbonate ester and may further include any desirable substituents. In one embodiment, the carbonate ester utilized in the cleaning composition may be a cyclic carbonate ester having a carbonate group linked by a 2- or 3-carbon bridge, such as, for example, ethylene carbonate, propylene carbonate, or trimethylene carbonate. In one embodiment, the carbonate ester can be selected from the group consisting of ethylene carbonate, propylene carbonate, trimethylene carbonate, and mixtures thereof.

The carbonate ester or esters may be present in any suitable amount. In one embodiment, the cleaning composition can comprise at least about 25, at least about 30, at least about 35, at least about 40, at least about 45, at least about 50, at least about 55, at least about 60, at least about 65, at least about 70, at least about 75, at least about 80, at least about 85, at least about 90, at least about 92 percent, at least about 95 and/or not more than about 99.9, not more than about 99, not more than about 97, not more than about 95, not more than about 90, not more than about 85, not more than about 80, not more than about 75, not more than about 70, not more than about 65, or not more than about 55 by weight of one or more carbonate esters. In another embodiment, the cleaning composition can comprise at least one carbonate ester in an amount of from about 50 to about 99, about 65 to about 97, or about 75 to about 95 percent by weight, based on the total weight of the composition. In still another embodiment, the cleaning composition can comprise from about 25 to about 80, about 30 to about 75, or about 35 to 70 percent by weight of one or more carbonate esters, based on the total weight of the composition. Alternatively, in another embodiment, the cleaning composition can comprise 100 percent by weight, or can consist essentially of at least one carbonate ester.

According to one embodiment, the cleaning compositions may include at least one thickener to enhance the ability of the composition to remain on the surface during cleaning. The thickener can be present in an amount of at least about 0.1, at least about 0.5, at least about 1, at least about 1.5, at least about 2, at least about 2.5, at least about 5 and/or not more than (or up to) about 20, not more than about 15, not more than about 10, or not more than about 7 percent by weight, based on the total weight of the composition. In another embodiment, the composition can include from about 0.1 to about 20 percent by weight, about 0.5 to about 15 percent by weight, or about 1 to about 10 percent by weight of a thickener. Additionally, the thickener can be present in an amount of up to 20 percent by weight, up to 10 percent by weight, or up to 5 percent by weight, based on the total weight of the cleaning composition. In another embodiment, the cleaning composition may consist essentially of or consist of a carbonate ester and a thickener. According to these embodiments, the cleaning composition may not be an aqueous composition and may, for example, include less than about 2, less than about 1, less than about 0.5, less than about 0.1 weight percent water, based on the total weight of the composition.

Examples of suitable thickeners can include, but are not limited to, organic or inorganic polymers or polymer emulsions, silicone or silicone emulsions, clays or organo-modified clays, cellulose gums, and combinations thereof. When the thickener includes an emulsion, the emulsion may be cationic, anionic, or non-ionic in nature. Additionally, when the thickener includes a polymer or polymer emulsion, it may be selected from the group consisting of polyethylene, polystyrene, polyacrylates, polyamides, polyesters, polyurethanes, polysulfide, polycarbonates, and combinations thereof. In some instances, the thickener may also include at least one cellulose gum.

Use of a thickener may be advantageous when, for example, the surface being treated is a non-horizontal surface. As used herein, the term “non-horizontal surface” refers to a surface oriented from horizontal by more than about 5°. In some embodiments, a non-horizontal surface can be oriented at an angle of at least about 10°, at least about 15°, at least about 30°, at least about 45°, at least about 60° and/or not more than about 175°, not more than about 160°, not more than about 135°, not more than about 120°, not more than about 105°, not more than about 90° from the horizontal. Some non-horizontal surfaces may be substantially vertical and may be aligned from vertical by no more than 5° (i.e., aligned from the horizontal from about 85° to about 95°). However, a cleaning composition that includes one or more thickeners may also be used on a substantially horizontal surface are oriented form horizontal by 5° or less.

In another embodiment, the cleaning composition of the present invention may be an aqueous composition including at least about 2, at least about 5, at least about 7, at least about 10 and/or not more than about 50, not more than about 45, not more than about 40, not more than about 35, not more than about 30, not more than about 25, not more than about 20, or not more than about 15 percent by weight of water, based on the total weight of the composition. In some cases, cleaning composition may comprise water in an amount of about 2 to about 30, about 7 to about 25, or about 10 to about 20 percent by weight, based on the total weight of the composition.

When the cleaning composition is an aqueous composition, it may also include one or more surfactants in a quantity sufficient to solubilize the carbonate ester into solution. In one embodiment, for example, the cleaning composition can comprise at least about 0.1, at least about 0.5, at least about 1, at least about 2, at least about 2.5, or at least about 5 and/or not more than about 30, not more than about 25, not more than about 20, not more than about 17, or not more than about 15 percent by weight of one or more surfactants, based on the total weight of the composition. In another embodiment, the composition may include from about 0.1 to about 30, about 1 to about 25, or about 5 to about 20 percent by weight of one or more surfactants, based on the total weight of the composition.

Any suitable type of surfactant may be used, including, for example, anionic surfactants, cationic surfactants, amphoteric surfactants, non-ionic surfactants, and combinations thereof. Specific examples of suitable surfactants can include, but are not limited to, polyglucosides, phenol alkoxylates, alkanolamides, polyalkylene oxides, polyethylene glycol ether of fatty alcohols, ethyoylates amines, alkylcarboxylates, alkylsulfonates, nonylphenol ethoxylates, alkylarylsulfonates, sulfosuccinates, alkylether sulfonates, phosphate esters, and combinations thereof.

In one embodiment, the cleaning composition includes a single surfactant, while in another embodiment, the cleaning composition may include a mixture of at least two, at least three, or more surfactants. When the composition includes two or more surfactants, the amount of each individual surfactant may be at least about 0.1, at least about 0.5, at least about 1, at least about 2, or at least about 2.5 and/or not more than about 15, not more than about 12, or not more than about 10 percent by weight, based on the total weight of the composition. The amount of each surfactant in a multi-surfactant system may be the same, or one or more surfactants may be present in a greater or lesser amount as compared to one or more of the other surfactants in the composition. Similarly, when two or more surfactants are used, the individual surfactants may be different surfactants within the same class or type (e.g., anionic, cationic, amphoteric, or non-ionic), or one or more of the individual surfactants may be of a different type or class than one or more of the other surfactants. For example, in one embodiment, the cleaning composition may include three different surfactants, with one being a cationic surfactant, one being an anionic surfactant, and the other being a non-ionic surfactant. Additional combinations are contemplated and fall within the scope of the present invention.

Additionally, other additives may be included in various formulations of the cleaning compositions described herein in order to enhance the properties or performance of the final composition. For example, in one embodiment, when the cleaning compositions is an aqueous composition formulated with mineralized or “hard” water, it may be desirable to include at least one optional chelant. When utilized, the chelant may be present in the composition in an amount of at least about 0.1, at least about 0.5, at least about 1, at least about 2 and/or not more than about 10, not more than about 8, not more than about 5, or not more than about 3 percent by weight, based on the total weight of the composition. Examples of suitable chelants include, but are not limited to, ethylenediaminetetraacetic acid (EDTA), triglycollamic acid (NTA), diethylenetriaminepentaacetic acid (DTPA), and combinations thereof. Other chelants may be used and are selected depending on the specific formulation of the cleaning composition, as well as its ultimate use.

Cleaning compositions of embodiments of the present invention can be prepared according to any suitable method and may, for example, be mixed or blended to form a final composition ready for end use. In one embodiment, the cleaning composition can be in the form of a gel or a coating, especially when the composition includes a thickener in the amounts described previously. In this case, the cleaning composition may have a viscosity of at least about 500 cP, at least about 1000 cP, at least about 1500 cP, at least about 2500 cP, or at least about 5000 cP and/or not more than about 100,000 cP, not more than about 75,000 cP, not more than about 50,000 cP, not more than about 25,000 cP, or not more than about 10,000 cP, or from about 500 cP to about 100,000 cP, about 1000 cP to about 75,000 cP, or about 1500 cP to about 50,000 cP, as measured according to ASTM Standard D2983-9. According to one embodiment, such cleaning compositions may be non-aqueous.

In another embodiment, the final cleaning composition can be a homogenous, or substantially homogenous, solution, and may optionally including water or another solvent in the amounts discussed previously. When the cleaning composition comprises a solution, it may have a viscosity of at least about 1 cP, at least 5 cP, at least about 10 cP, at least about 25 cP, at least about 50 cP, at least about 100 cP and/or not more than about 5000 cP, not more than about 1000 cP, not more than about 500 cP, not more than about 250 cP, or not more than about 100 cP, or from about 1 cP to about 1000 cP, about 5 cP to about 500 cP, or about 10 cP to about 250 cP, as measured by ASTM Standard D4016-8. In one embodiment, such compositions may be aqueous cleaning compositions.

If the cleaning composition is an aqueous composition, it may be formed by first preparing a concentrated cleaning composition and then diluting the concentrated composition with sufficient amount of water (or other solvent) to produce a final composition suitable for the desired end use. Such a dilution may take place at any time during the manufacture of the solution, or may be carried out by the end user just prior to application of the composition to the surface requiring cleaning. When diluted, the dilution ratio of the concentrated composition to the solvent may be at least about 1:1, at least about 1:2, at least about 1:4, or at least about 1:10 and/or not more than about 1:50, not more than about 1:25, not more than about 1:20, or not more than about 1:15. However, specific dilution ratios may vary, depending on the specific application.

Even when diluted, the aqueous cleaning composition may still have a relatively high concentration of carbonate ester. For example, in one embodiment, the concentration of carbonate ester in the diluted composition may still be at least about 45, at least about 50, at least about 55, at least about 60, at least about 65, at least about 70 and/or not more than about 90, not more than about 85, not more than about 80, or not more than about 75 percent by weight based on the total weight of the composition. As discussed previously, diluted compositions may also include at least one surfactant and an optional chelant, especially when the composition is diluted using mineralized or hard water.

Cleaning compositions according to embodiments of the present invention have a relatively neutral pH. In one embodiment, for example, the cleaning compositions can have a pH of at least about 4, at least about 5, at least about 6 and/or not more than about 10, not more than about 9, or not more than about 8. This is in contrast to other conventional surface cleaners, which may have an acidic (e.g., less than 4) or a basic (e.g., greater than 10) pH. Further, cleaning compositions described herein are substantially non-toxic and are non-volatile (i.e., are low volatile organic compound or VOC).

According to another embodiment, the cleaning compositions of the present invention may be used to remove one or more types of soil from a surface. As mentioned previously, the term “soil” refers to any undesirable or unwanted component. In many cases, the soils being removed are byproducts of a reaction or other process and are very chemically complex, therefore exact characterization of the specific soil may not be possible. However, regardless of the chemical and/or physical properties of the soil itself, the cleaning compositions according to embodiments of the present invention may be effective to remove at least a portion of, or substantially all, of the soil adhered to, deposited on, stuck to, or otherwise disposed on one or more surfaces.

Surfaces suitable for cleaning with the method of the present invention may be oriented in nearly any configuration. For example, in one embodiment, the surface may be a non-horizontal surface, while, in another embodiment, the surface may be substantially horizontal. The surface can be substantially or entirely planar and/or can include one or more corners, grooves, channels, curves, bends, or other topographical features. The surface to be cleaned can be at least partially rounded and may be partially or totally enclosed, as with, for example, the internal surface of a pipe or vessel. The surface to be treated may be made of a single type of material, or can comprise two or more different types of material. In one embodiment, the surface being treated may be a hard surface. Examples of suitable surface materials include, but are not limited to, metal and metal alloy surfaces such as those formed of stainless steel, carbon steel, and nickel metal alloys; refractory-type materials such as tile, brick, porcelain, and ceramics, as well as stone such as marble and granite; glass; plastics and plastic-coated surfaces; and combinations thereof.

According to the method of the present invention, the soil is at least partially removed from one or more surfaces by contacting the surface with one or more cleaning compositions, such as, for example, one or more of the cleaning compositions described herein. In one embodiment, the contacting can include applying the composition to at least a portion of the surface using, for example, a hose, a bucket, a brush, a roller, a towel, a sprayer, an aerosol applicator, or combinations thereof. In one embodiment, the cleaning composition may be circulated thorough the equipment being cleaned using existing or temporary pumps or other equipment. In another embodiment, the cleaning composition may be applied using a low- or high-pressure spray nozzle. In yet another embodiment, the cleaning composition may be applied as a coating, gel, or even a foam with an applied thickness of at least about 1, at least about 2, at least about 5 and/or not more than about 30, not more than about 20, or not more than about 10 mm, or from about 1 to about 30, about 2 to about 20, or about 5 to about 10 mm, measured at the thickest part of the applied composition. The composition may be applied to the surface in a single application or may be applied at least 2, at least 3, or at least 4 times, with or without interim rinsing.

In one embodiment, after application, the cleaning composition may be allowed to remain on the surface for a set period of time before being rinsed or otherwise removed from the surface. This “soak time” allows the composition to contact and interact with the soil, thereby loosening, dissolving, detaching, or otherwise removing all or a portion of the soil from the surface being treated. In one embodiment, the cleaning composition may be left substantially undisturbed during the soak time, while, in another embodiment, the cleaning composition may be agitated by rubbing, scrubbing, brushing, or similar action during all or a part of the soak time. Such agitation of the cleaning composition on the surface may be carried out manually by one or more individuals, or it may be done automatically by one or more mechanically automated devices.

The total duration of the soak time of the composition on the surface varies depending on the composition and type of soil, but, in some embodiments, it may be at least about 1 second, at least about 5 seconds, at least about 10 seconds, at least about 30 seconds, at least about 1 minute, at least about 5 minutes, at least about 10 minutes, at least about 30 minutes, at least about 1 hour and/or not more than about 16 hours, not more than about 12 hours, not more than about 8 hours, not more than about 4 hours, not more than about 2 hours, not more than about 1 hour, not more than about 30 minutes, not more than about 15 minutes, not more than about 10 minutes, not more than about 5 minutes, not more than about 1 minute, or not more than about 30 seconds. The soak time may be measured from completion of the application of the cleaning composition and the initiation of its removal via, for example, rinsing.

In one embodiment, after the soak time has expired, at least a portion of the applied cleaning composition can be removed from the surface using a rinse fluid. The rinse fluid can be an unpressurized or pressurized liquid or gas applied to the surface to remove at least a portion of the cleaning composition and/or soil therefrom. In one embodiment, the rinse fluid may be a pressurized gas applied via a sprayer, hose, nozzle, wand, or any other suitable equipment. Preferably, when the rinse fluid comprises a gas, the gas is inert to and will not adversely interact with the surface or soil. Examples of inert gases suitable for use as a rinse fluid include air and nitrogen.

In another embodiment, the rinse fluid may be a rinse liquid applied to the surface in as a pressurized or unpressurized liquid. In one embodiment, the rinse liquid may be an aqueous liquid comprising at least about 1, at least about 2, at least about 5, at least about 10, at least about 15 percent by weight of water. In one embodiment, the rinse liquid may consist of water, while, in other embodiments, it may also include one or more additional components. These additives may include, for example, abrasives, such as particles of sand, clay, minerals, and other similar materials, to facilitate removal of soil from the surface.

Additionally, in one embodiment, the rinse fluid may be a second cleaning composition applied to the surface to remove at least a portion of the first cleaning composition and/or the dissolved, detached, or otherwise removed soil. This second cleaning composition used in or as the rinse liquid may also comprise one or more carbonate esters of the type and/or in the amounts described previously. Preferably, when used as a rinse liquid, the second cleaning composition may be a water-diluted cleaning composition formed by adding water to a concentrated cleaning composition, as described in detail above. In some embodiments, the first and second cleaning compositions may have similar compositions, while, in other embodiments, the first and second cleaning compositions may be different. In some cases, the surface may be further rinsed with water or other rinse fluid after application of the second cleaning composition. Overall, the method of cleaning described herein may be effective to remove at least about 50, at least about 60, at least about 70, at least about 80, at least about 90, at least about 95, or at least about 99 percent of the soil from the surface being treated.

The surfaces suitable for treatment using the cleaning compositions and methods as described herein can be any surface requiring cleaning. In some cases, the surface being treated can be part of a vessel, pipe, or other piece of equipment associated with an oil and gas production and/or processing facility, such as, for example, a system used for the hydraulic fracturing (i.e., “fracing”) of subterranean oil and gas formations. In such systems, the exact composition and/or nature of the soil to be removed may be very difficult to characterize, as often such deposits are formed from the combination of several different types of material under extreme temperatures and/or pressures. However, it has been advantageously discovered that cleaning compositions and methods according to the present invention are particularly effective for removing these types of deposits formed in the vessels, piping, and other equipment in an oil and gas fracing facility.

Additionally, one or more cleaning compositions as described herein may be useful in removing soil from at least one surface in a variety of other applications. For example, methods and compositions according to various embodiments of the present invention may be used to remove solid deposits formed in water treatment facilities and systems, or to remove polymeric deposits from chemical reactors, tanks, and the associated piping. Cleaning compositions and methods of the present invention may also be used to clean surfaces of piping or equipment used in other systems, including, for example, polymer production or processing systems, chemical production or processing systems, paper and paper product processing or production systems, systems for processing or treating biological materials, industrial or municipal water treatment facilities, food and beverage production or processing systems, or systems designed to process industrial or municipal waste. Other end uses are also contemplated and fall within the scope of the present invention.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A method for removing soil from at least one surface of a pipe, vessel, or other piece of equipment associated with an oil and gas production and/or processing system, the method comprising:
contacting at least a portion of the surface with a cleaning composition that comprises at least one carbonate ester, wherein the contacting is sufficient to remove at least a portion of the soil from the surface to thereby provide an at least partially cleaned surface.

2. The method of claim 1, wherein the carbonate ester is selected from the group consisting of ethylene carbonate, propylene carbonate, trimethylene carbonate, and combinations thereof.

3. The method of claim 1, wherein the composition includes from about 70 to about 99 percent by weight of the carbonate ester and from about 0.1 to about 10 percent by weight of at least one thickener.

4. The method of claim 3, wherein the surface being contacted is a non-horizontal surface.

5. The method of claim 1, further comprising, prior to the contacting of the surface, diluting a concentrated cleaning composition with water to thereby provide a water-diluted cleaning composition, wherein at least a portion of the contacting is carried out using the water-diluted cleaning composition.

6. The method of claim 5, wherein the water-diluted cleaning composition comprises at least 50 percent by weight of the carbonate ester, from about 5 to about 25 percent by weight of at least one surfactant, and from about 2 to about 30 percent by weight of water, based on the total weight of the composition.

7. The method of claim 1, wherein the contacting includes applying the cleaning composition to the surface and rinsing at least a portion of the cleaning composition and/or at least a portion of the soil from the surface using a rinse fluid.

8. The method of claim 7, wherein the rinse fluid is an aqueous rinse fluid that comprises a second cleaning composition comprising one or more carbonate esters and at least one surfactant.

9. A method for removing soil from a surface, the method comprising: contacting at least a portion of a surface with a cleaning composition that comprises at least 50 percent by weight of at least one carbonate ester and at least one surfactant and/or a thickener, wherein the contacting is sufficient to remove at least a portion of the soil from the surface.

10. The method of claim 9, wherein the surface is associated with a pipe or other piece of equipment used in a system for producing or processing oil, natural gas, polymers, chemicals, paper or paper products, biological materials, industrial or municipal water, food or beverages, or industrial waste.

11. The method of claim 9, wherein the carbonate ester is selected from the group consisting of ethylene carbonate, propylene carbonate, trimethylene carbonate, and combinations thereof.

12. The method of claim 9, wherein the cleaning composition comprises from about 70 to about 99 percent by weight of the carbonate ester and from about 0.1 to about 10 percent by weight of the thickener.

13. The method of claim 9, further comprising, prior to the contacting of the surface, diluting a concentrated cleaning composition with water to thereby provide a water-diluted cleaning composition, wherein at least a portion of the contacting is carried out using the water-diluted cleaning composition, wherein the water-diluted cleaning composition comprises at least 50 percent by weight of the carbonate ester, from about 5 to about 25 percent by weight of at least one surfactant, and from about 2 to about 30 percent by weight of water, based on the total weight of the composition.

14. The method of claim 9, wherein the contacting includes applying the cleaning composition to the surface and rinsing at least a portion of the cleaning composition and/or at least a portion of the soil from the surface using a rinse fluid, wherein the rinse fluid is an aqueous rinse fluid comprising a second cleaning composition that comprises one or more carbonate esters and at least one surfactant.

15. A composition for cleaning surfaces, the composition comprising:
(a) at least 50 percent by weight of at least one carbonate ester;
(b) up to 20 percent by weight of at least one thickener; and
(c) up to 30 percent by weight of at least one surfactant,
wherein each of the percentages are based on the total weight of the composition.

16. The composition of claim 15, wherein the carbonate ester is selected from the group consisting of ethylene carbonate, propylene carbonate, trimethylene carbonate, and combinations thereof.

17. The composition of claim 15, wherein the composition comprises at least 70 percent by weight of the carbonate ester and at least 0.1 percent by weight of the thickener.

18. The composition of claim 15, wherein the composition consists essentially of the carbonate ester and the thickener.

19. The composition of claim 15, wherein the composition includes at least 60 percent by weight of the carbonate ester, at least 1 percent by weight of the surfactant, and at least 5 percent by weight of water.

20. The composition of claim 15, wherein the composition consists essentially of the carbonate ester, the surfactant, water, and an optional chelating agent.
